(19) United States
(12) Patent Application Publication
(10) Pub. No.: US 2014/0375808 A1
(43) Pub. Date: Dec. 25, 2014

(54) APPARATUS, METHOD, AND COMPUTER READABLE MEDIUM FOR MONITORING A NUMBER OF PASSENGERS IN AN AUTOMOBILE

(71) Applicant: UTECHZONE CO., LTD., New Taipei City (TW)

(72) Inventors: Chia Wen Kao, New Taipei City (TW); Po Tsung Lin, New Taipei City (TW); Chih Heng Fang, New Taipei City (TW); Chia Chun Tsou, New Taipei City (TW)

(73) Assignee: UTECHZONE CO., LTD., New Taipei City (TW)

(21) Appl. No.: 14/092,581

(22) Filed: Nov. 27, 2013

(30) Foreign Application Priority Data
Jun. 24, 2013 (TW) 102122409

(51) Int. Cl. H04N 7/18

(52) U.S. Cl. CPC H04N 7/18
USPC 348/148

(57) ABSTRACT

A monitor is utilized for installing inside an automobile to monitor a number of passengers in an automobile. The monitor includes an image capturing device, and a processing unit is connected to the image capturing device. The image capturing device successively captures a plurality of images in the automobile. The processing unit receives the images from the image capturing device to arrange an image sequence, wherein the processing unit includes an image dividing module, an image processing module, and a motion detecting module. The image dividing module divides each of the images into a plurality of recognition blocks, the image processing module compares the recognition blocks of consecutive images in the image sequence to acquire an image variance value, and the motion detecting module has a threshold value and determines the recognition blocks as a human-present condition when the image variance value surpasses the threshold value.

### BACKGROUND OF THE INVENTION

1. Technical Field

The present invention relates to a monitor for use in an automobile. More particularly, the present invention relates to a monitor for installing inside an automobile to monitor a number of passengers in an automobile.

2. Description of Related Art

Generally, transportation system plays an important role in an economy development of a country. The transportation system and the economy development supplement and complement each other; namely, the more mature the transportation is, the more prosperous the economy is. Therefore, the related studies show that economy, transportation and environment interpret each other.

With the progress of the economy, the living qualities of human beings are significantly improved. It brings many marginal benefits such as the popularization of private vehicles and etc. However, the massive increase of the private vehicles causes traffic congestion. Specifically, when private vehicles are over popularized and their space demands are greater than the available road capacity, the traffic congestion easily happens during rush hours. When it occurs, a number of negative impacts happen, such as environmental pollution, the increase of drivers' commuting time and possibility of the economic loss. These problems have already happened in many developed-countries and developing-countries which have great rural-urban disparities. In order to solve these problems, the high-occupancy vehicle control has been commonly proposed as a way to force the number of people in vehicles being more than one occupant. When the average number of people in vehicles is increased, the vehicle number on the road would be less, and thereby lowering the rate of traffic congestion. Another way to control the number of private vehicles is to establish a high-occupancy vehicle lane (HOV lane). Its purpose is to encourage carpooling by dividing the lanes into a high-occupancy vehicle lane and a regular vehicle lane. However, employing many workers to check the number of people in the vehicles is necessary in both of the ways. Therefore, it is obvious that these controlling ways not only waste labors but also cause traffic congestion in a large traffic flow area. For example, implementing the high-occupancy vehicle control is likely to cause the congestion at the entrances of a highway interchange. As a result, it may fail to solve the problem of traffic congestion.

Taiwan patent no. M414625 discloses a controlling system for touring bus, and the system is combined with a RFID chip to control the number of people in a tour bus. When people get on or off the bus, the system automatically makes the record through the RFID information so that the time to check the number of people is saved. Nevertheless, if this technique is used in the high-occupancy vehicle control, it cannot forcibly control the number of people in buses, such as the condition that the people who do not carry RFID chip cannot be controlled effectively. Therefore, controlling the number of people in a vehicle neither by labor nor by RFID chip apparently fails to reach the expected results.

### SUMMARY OF THE INVENTION

The problem to be solved in this present invention lies in that when conducting high-occupancy vehicle control, the occupancy must be checked by a labor with the shortcoming that effectively controlling cannot be achieved.

One aspect of the present invention is to provide a monitor for installing inside an automobile to monitor a number of passengers in an automobile. The monitor includes an image capturing device, and a processing unit is connected to the image capturing device. The image capturing device successively captures a plurality of images in the automobile. The processing unit receives the images from the image capturing device to arrange an image sequence, wherein the processing unit includes an image dividing module, an image processing module, and a motion detecting module. The image dividing module divides each of the images into a plurality of recognition blocks, the image processing module compares the recognition blocks of consecutive images in the image sequence to acquire an image variance value, and the motion detecting module has a threshold value and determines the recognition blocks as a human-present condition when the image variance value surpasses the threshold value.

In a preferable embodiment, the image variance value is a distance of variance vector acquired from an intermediate coordinate that distinguishes two image trait blocks after the image processing module removes a background of the consecutive images in the image sequence.

In a preferable embodiment, the consecutive images respectively includes a pixel matrix, and the image variance value is a sum of an absolute value of a subtraction between the pixel matrixes of the consecutive images.

In a preferable embodiment, the consecutive images respectively includes a pixel matrix, and the image variance value is a proportion between the recognition blocks and a difference value matrixes acquired from a subtraction between the pixel matrixes of the consecutive images.

In a preferable embodiment, each of the recognition blocks respectively includes a depth reference range, and the image capturing device includes two cameras that measure the depths of the recognition blocks to detect whether there are objects within the depth reference range.

In a preferable embodiment, each of the recognition blocks respectively includes a depth reference range, and the image capturing device is a depth camera that measures the depths of the recognition blocks to detect whether there are objects within the depth reference range.

In a preferable embodiment, the processing unit includes a counter that records the number of people through the motion detecting module, and the monitor includes a wireless communication device that transmits data of the number of people to a remote server.

In a preferable embodiment, the wireless communication device is established on the wireless communication system 3G, 4G, or Wi-Fi of a communication protocol.

In a preferable embodiment, the monitor further includes a driver attention alarm, and the driver attention alarm includes another image capturing device that captures a facial image of the driver and records a number of winks in the facial image, and a warning indicator connected to the another image capturing device that sends out a warning when the number of winks in a stipulated time surpasses a first threshold value.

In a preferable embodiment, the monitor further includes a driver attention alarm, and the driver attention alarm includes another image capturing device that captures a facial image of the driver and detects an angle of face turning in the facial image, and a warning indicator connected to the another image capturing device that sends out a warning when the angle of face turning surpasses a second threshold value.

Another aspect of the present invention is to provide a method for monitoring a number of passengers in an automobile, including: a) successively capturing a plurality of images in the automobile through an image capturing device, and arranging the images into an image sequence; b) dividing each image of the image sequence into a plurality of recognition blocks; c) comparing the recognition blocks of consecutive images in the image sequence to acquiring an image variance value; and d) comparing the image variance value with a threshold value, and when the image variance value surpasses the threshold value, judging the recognition block as a human-present condition.

In a preferable embodiment, the consecutive images respectively includes a pixel matrix, and the image variance value is a proportion between the recognition blocks and a difference value matrixes acquired from a subtraction between the pixel matrixes of the consecutive images.

In a preferable embodiment, each of the recognition blocks respectively includes a depth reference range, and in step b), the image capturing device measures the depths of the recognition blocks to detect whether there are objects within the depth reference range.

In a preferable embodiment, the method further includes a step e), the step in which by the results of detecting the recognition blocks the number of passengers inside the automobile is counted and a warning indication is transmitted to a remote server when the number of passengers fails to reach a required number of regulation.

Another aspect of the present invention is to provide a computer-readable recording medium, installed on an electronic device, wherein the computer-readable recording medium is recorded with a method for monitoring the number of passengers in automobiles, and the method is according to the method including: a) successively capturing a plurality of images in the automobile through an image capturing device, and arranging the images into an image sequence; b) dividing each image of the image sequence into a plurality of recognition blocks; c) comparing the recognition blocks of consecutive images in the image sequence to acquiring an image variance value; d) comparing the image variance value with a threshold value, and when the image variance value surpasses the threshold value, judging the recognition block as a human-present condition.

Therefore, the present invention attains the following benefits compared to the prior art:

1. Using the image capturing device, the present invention effectively obtains the number of persons in a vehicle. Therefore, when a high-occupancy vehicle control is conducted, the monitoring center remotely controls the occupants in a vehicle using the image capturing device without the shortcomings of labor-monitoring.

2. The present invention uses a depth camera to detect whether there are objects within the depth reference range in advance, thereby improving the detecting accuracy.

3. The present invention can further include an on-board diagnostics (OBD) or wireless communication system so that the monitor of the present invention is started when the vehicle is started, going on a highway or into a HOV lane, thereby achieving effective monitoring.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 shows a block diagram of the monitor of the present invention.

FIG. 2 shows a usage state diagram of the present invention.

FIG. 3 shows a usage state diagram of the present invention.

FIG. 4 shows a flow chart of the method of the present invention for monitoring a number of passengers in an automobile.

FIG. 5 shows a flow chart of the method of the present invention for monitoring a number of passengers in an automobile.

FIG. 6 shows the algorithm flow chart of the first embodiment of the present invention.

FIG. 7 shows the algorithm flow chart of the second embodiment of the present invention.

### DETAILED DESCRIPTION OF THE INVENTION

The present invention of the monitor to monitor a number of passengers in an automobile will be described with drawings as below.

The terms “a” and “an” refer to one or to more than one (i.e., to at least one) of the grammatical object of the article.

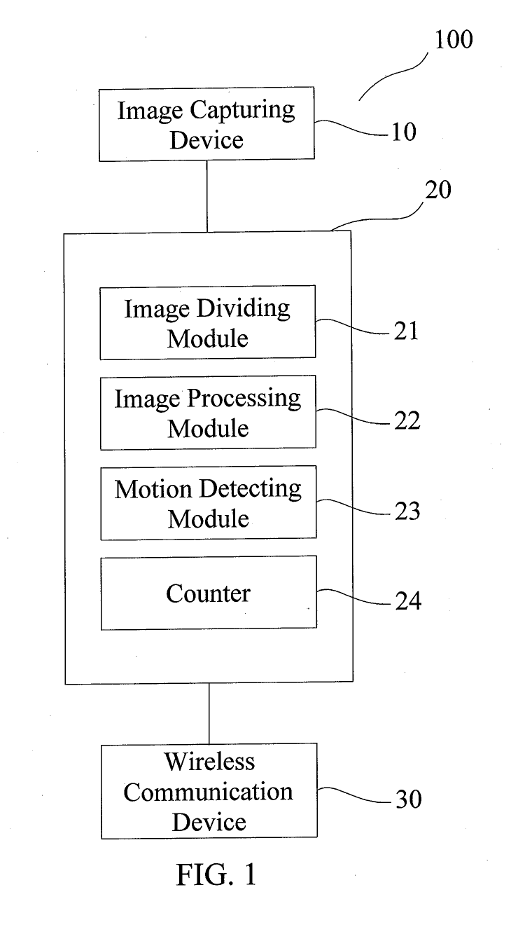

Please refer to FIG. 1, which shows a block diagram of the monitor of the present invention.

The present invention provides a monitor 100 to monitor a number of passengers in an automobile. The monitor 100 comprises an image capturing device 10, a processing unit 20 connected to the image capturing device 10, and a wireless communication apparatus 30 connected to the processing unit 20. The image capturing device 10 can be a camera to capture a two-dimensional image, or a depth camera which captures a depth parameter from the image. In the present embodiment, the image capturing device 10 can be a TwinCAM, or an active depth camera, which adds the depth degree as an auxiliary parameter.

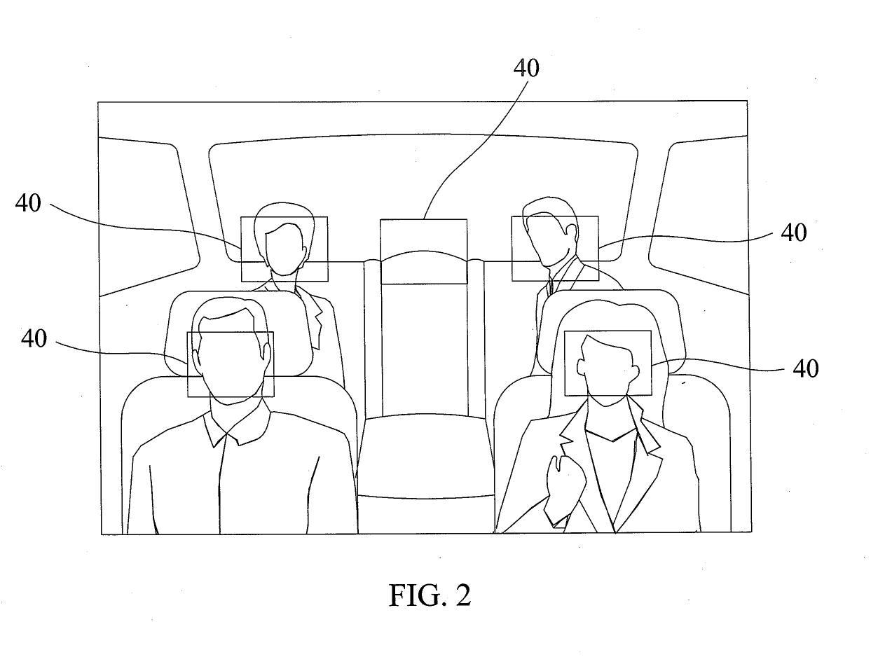

The processing unit 20 is connected to the image capturing device 10 to receive a plurality of consecutive images appeared inside the automobile captured by the image capturing device 10, and then arranges the images into an image sequence. The processing unit 20 mainly includes an image dividing module 21, an image processing module 22, a motion detecting module 23, and a counter 24. The image dividing module 21 divides each of the images into a plurality of recognition blocks 40 (as shown in FIG. 2). Wherein, the recognizable range of the recognition block 40 is set up by car's OEM (Original Equipment Manufacturing), ODM (Original Design Manufacturing), or is adjustable by the installer, or is automatically adjustable by the processing unit based on the environmental factors. For example, based on the depth parameter, the space can be divided into several blocks. However, the above disclosures are only for illustrating the equivalent arrangement of the invention, without any restrictions to the present invention.

The image processing module 22 compares the recognition blocks 40 of consecutive images in the image sequence to acquire an image variance value. The term “consecutive images” used herein refers to the different figures derived from the same image sequence. For example, if the number of the captured images are 12 images, the images to be compared can be the 1^{st} and the 2^{nd} image, or the 1^{st} and 12^{th} image; it does not restrict to choose the two adjacent images. Specifically, the comparing methods can be the background subtraction method, the adaptive background subtraction method, temporal difference method, etc.

The motion detecting module 23 has a threshold value, and the threshold value can be acquired from the conclusion of the large numbers of the statistic and experimental data. The threshold value is used for comparing with the image variance value. If one of the image variance value in a recognition block 40 surpasses the threshold value, then the motion detecting module 23 determines that the recognition block 40 has an moving objects and transmits a True value to the counter 24. After the counter 24 receives the True value, it calculates the amount of the received True values and records the amount of the moving objects in the recognition block 40, so that the number of people in the automobile is obtained.

The wireless communication device 30 is connected to the processing unit 20. The protocol of the wireless communication device 30 can be established on the wireless communication system 3G, 4G, WiFi system, etc., to connect with a remote server. In an exemplary embodiment, the above mentioned wireless communication device 30 can be a portable mobile communication device, or the communication apparatus which is set in the automobile and is connected to the OBD (On-Board Diagnostics) in advance. In another exemplary embodiment, the present invention can be coordinated with a directional antenna which is set on or close to the high occupancy vehicle lane in a detecting distance. As the automobile passes the lane, the automobile receives a triggering signal radiated from the directional antenna and thereby starting the monitor 100 of the present invention to count the number of people in the automobile.

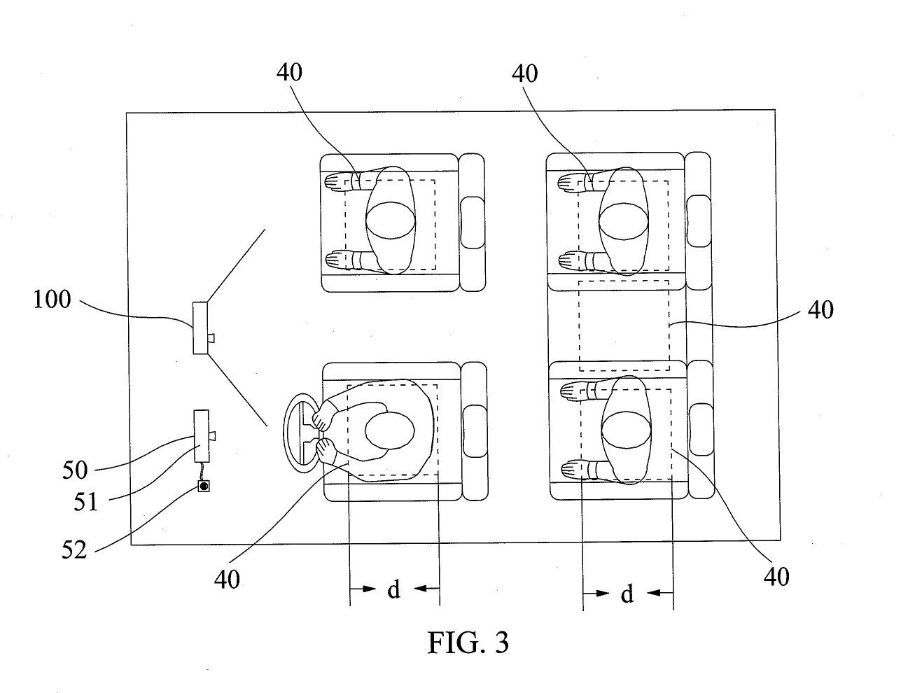

Please also refer to FIG. 2 and FIG. 3, which show a usage state diagrams of the present invention.

In order to separate each space of the recognition blocks 40 to avoid the recognition blocks 40 being overlapped or disturbed by each other, the image capturing device 10 can be a TwinCam, or a depth camera to get the depth value of the image. Therefore, as the image capturing device 10 divides an image into recognition blocks 40, the depth value can be used as an auxiliary reference. More particularly, each of the recognition blocks 40 has a depth reference range “d” and the image capturing device 10 can get the depth value of the image by the camera or an infrared rays receiver. Besides, this depth value can be identified if any objects exist inside the recognition block 40 before confirmation of the image motion.

Moreover, the present invention further includes a driver attention alarm 50 in order to detect the driver's attention when driving. Also, the driver attention alarm 50 includes another image capturing device 51 and an alarm device 52 which is connected to the image capturing device 51. This capturing device 51 is installed in front of the driver in order to detect the driver's attention condition. More specifically, the image capturing device 51 includes a face-detecting function and an eye-closing detecting function. When the driver starts the automobile, the ODB system delivers an activating signal to the image capturing device 51. At the meantime, the image capturing device 51 starts to make a record of the face image of the driver, and further records the number of winks and the angle of face turning based on the facial images. If the number of winks of the driver surpasses a first threshold value in a stipulated time, or the angle of face turning of the driver surpasses a second threshold value in a stipulated time, the alarm device 52 makes a warning sound to alert the driver.

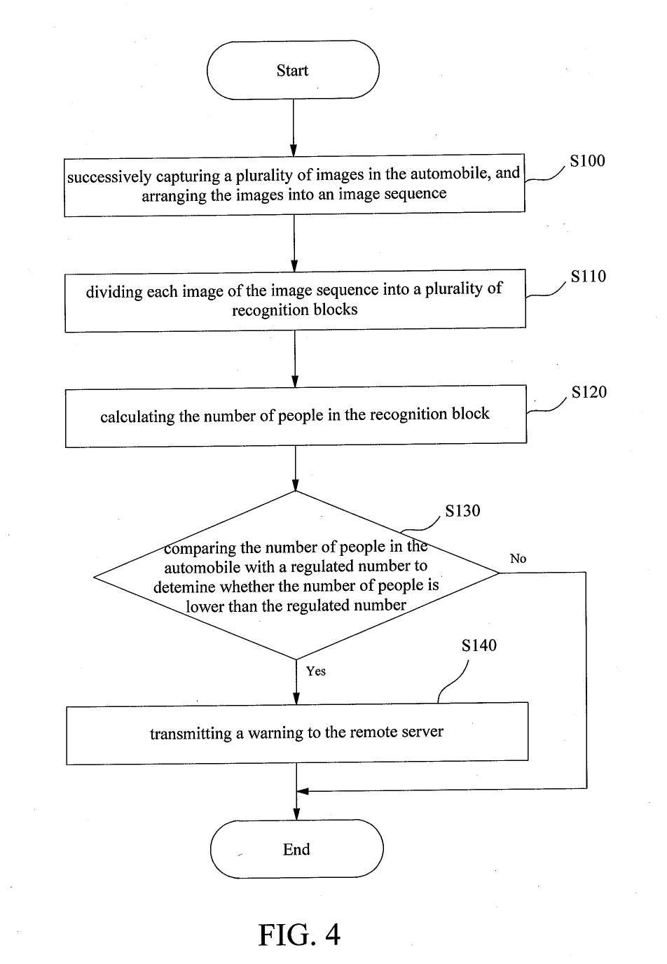

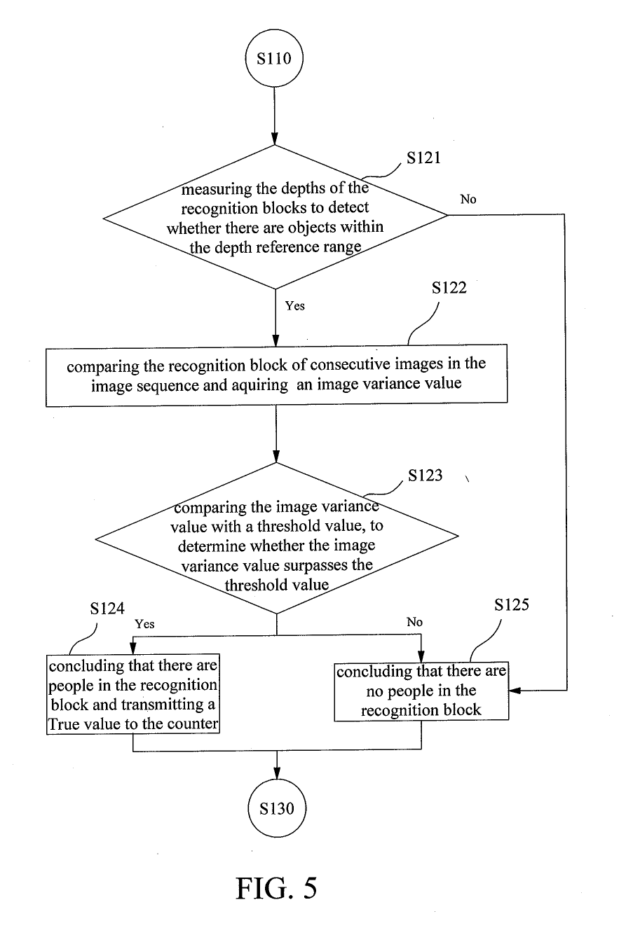

Please also refer to FIG. 4 and FIG. 5, which show the diagrams of the method for monitoring a number of passengers in an automobile of the present invention.

The present invention provides a monitoring method to monitor the number of passengers in the automobile. The method comprises the following steps: at the beginning, when users start the engine, the ODB system delivers an activating signal to the processing unit 20 so that the processing unit 20 gets the information that the engine is under the starting status. Therefore, the processing unit 20 starts the image capturing device 10 (also, the image capturing device 10 can be started by external conditions) and the image capturing device 10 successively captures a plurality of images in the automobile. The processing unit 20 then arranges the images into an image sequence (step S100). Then, each image in the image sequence is divided into a plurality of recognition blocks 40 through a image-dividing module 21 (step S110). When images are divided into a plurality of recognition blocks 40, the variance value of each recognition block is calculated so that the number of persons in the recognition blocks 40 can be known (step S120). Please refer to FIG. 5, which illustrates the detailed steps on how to identify whether there has person present in the recognition block. First, the capturing device concurrently measures the depths of the recognition blocks to detect whether there are any objects within the depth reference range “d” (step S121). If no objects present in the depth reference range “d”, then no person present in the recognition block is determined (step S125). However, if there are objects in the the depth reference range “d”, then the subsequent step is conducted. It should be noted that the depth measure range is set in advance, so that this step can be operated before or after the image-dividing step). Further, the image-processing module 22 compares the recognition block 40 of consecutive images in the image sequence and acquires an image variance value (step S122). The motion-detecting module 23 compares the image variance value with a threshold value (step S123). If the image variance value surpasses the threshold value, it is concluded that there are people present in the recognition block 40 and a True value is also generated and is transmitted to the counter 24 (step S124). Otherwise, if the image variance value is under the threshold value, it is concluded that there has no people present in the recognition block 40 (step S125). Finally, the counter 24 calculates the number of passengers in the automobile based on the received True value. If the number of passengers fails to reach a regulated number (usually 2 people) (step S130), the counter transmits a warning to a remote server (step S140). On the other hand, if the passenger numbers surpass the regulated number, then the detecting loop is ended.

In order to understand the equivalent range of the variance value of images of the present invention, several implementing ways are proposed for detecting motion change of the images.

The following is first embodiment.

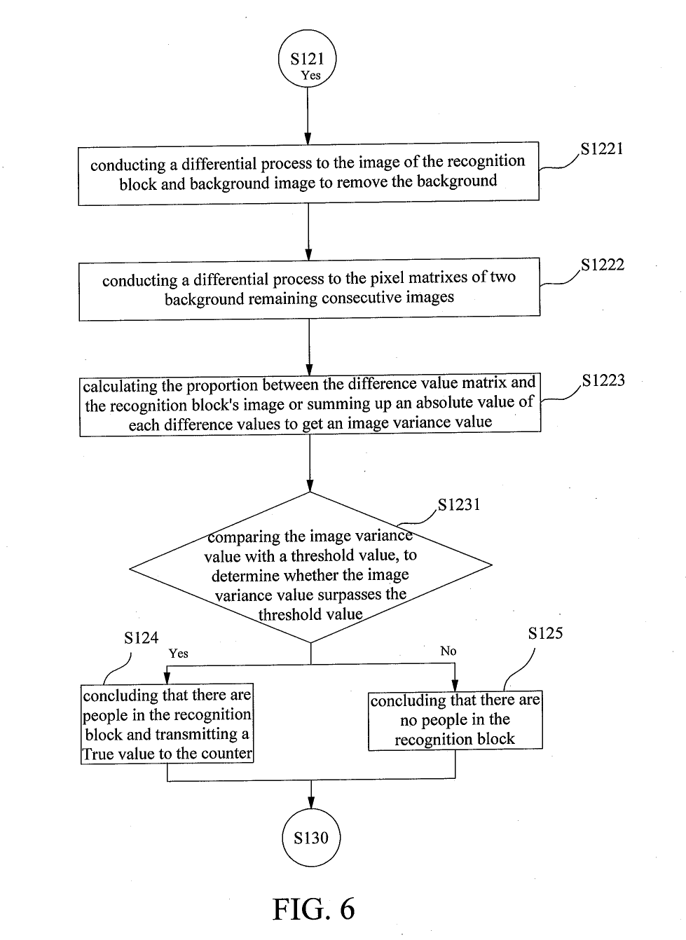

Please also refer to FIG. 6, which shows the algorithm flow chart of the first embodiment. As the flow chart shows, the image-processing module obtains the background image of each recognition block 40 first, and saves the background image as a reference image. The image processing module 22 gets the image sequences, which are already divided by an image-dividing process. Then, through a differential process, the image processing module 22 removes the background image of the recognition block 40 (step S1221) and the background removed consecutive images respectively include a pixel matrix. The step is followed by a differential process to the pixel matrix of two consecutive images to acquire the difference value matrixes (step S1222). Subsequently, an image variance value is obtained based on the proportion between the difference value matrix and the recognition block's 40 image or based on the sum of an absolute values of each difference value of the difference value matrixes (step S1223). The image variance value is compared with a threshold value (step S1231). If the image variance value surpasses the threshold value, the recognition block is judged as human present, and a True value is transmitted to the counter 24 (step S124).

In the present embodiment, the above mentioned differential process is a subtraction between gray values of the consecutive images of the same position, or a vector distance of the chromaticity coordinate between the two consecutive pixels of the same position. Since there are several reference values available, the present invention is not limited to any certain types. Moreover, it shall be noted that in the present embodiment, the background removing process is not an essential step.

The second embodiment is illustrated as follows.

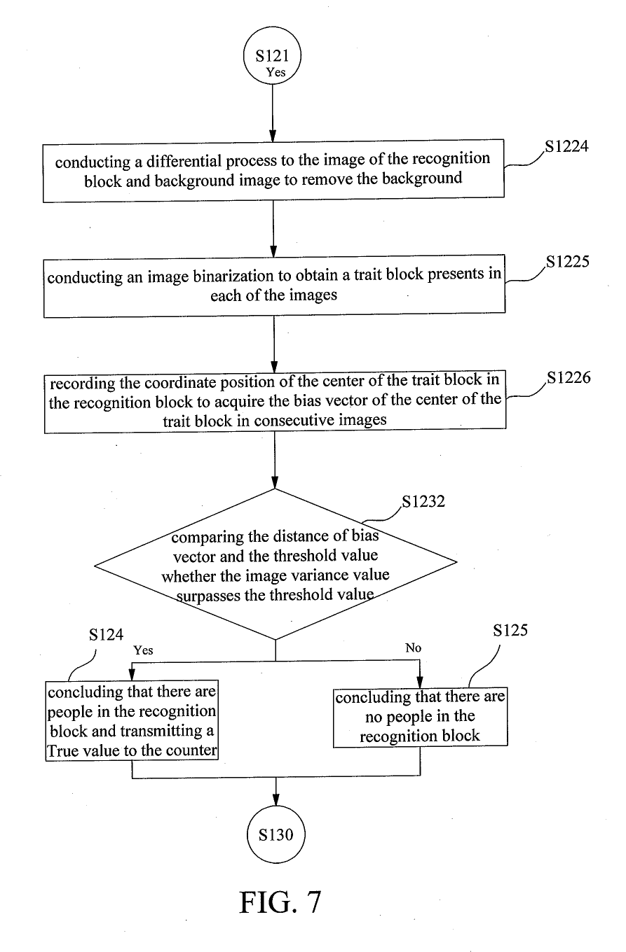

Please also refer to FIG. 7, which shows the algorithm flow chart of the second embodiment of the present invention. As the flow chart shows, the image coordinates in the trait block is acquired based on the trait of human bodies. First, the image processing module 22 obtains the background image of each recognition block 40 and saves the background image as a reference image. Then, the image processing module 22 obtains the image sequences that are already divided by image dividing process, and a differential process is conducted to the image of the recognition block 40 and the background image respectively to complete background removing (step S1224). After background removing, the image processing module 22 conduct a image binarization process in order to get the border of the image. The image processing module then obtains a trait block that is presented in each of the images (i.e., the trait block is a block having a much bigger distinct from the surrounding images) (step S1225). Then, the coordinate position of the center of the trait block in the recognition block 40 is recorded, and a bias vector of the center of the trait block in consecutive images is obtained (which is equal to the image variance value) (step S1226). Subsequently, the distance of bias vector is compared to the threshold value. If the distance of bias vector surpasses the threshold value, the recognition block is judged as human present, and a True value is transmitted to the counter 24 (step S124).

The above examples are only regarded as parts of embodiment for reference. In the present invention, the comparison method shall not be limited to the above mentioned two embodiments.

In addition, the method of the present invention is able to be programmed into a software program that can be saved in a computer readable recording medium such as a Disc, a hard disc, or a semiconductor memory device and the computer-readable recording medium is accessible and is executed on an electronic device which is able to read the computer-readable recording medium. In particularly, the electronic devices is a small portable electronic device, an EDR (event data recorder), a driving security assisting device, an ODB system of vehicle, or the computer equipment and the like.

In conclusion, the present invention detects the number of passengers in the automobiles via the image capturing device. During the high occupancy vehicle control, the control center remotely monitor the passenger number by the image capturing device in the automobile and thereby avoiding the inconvenience of controlling passenger numbers by labor. Besides, uses a depth camera to detect whether there are objects within the depth reference range in advance, thereby improving the detecting accuracy. Furthermore, the present invention can further include an OBD or wireless communication system so that the monitor of the present invention is started when the vehicle is started, going on a highway, or into a HOV lane, thereby achieving effective monitoring.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A monitor for installing inside an automobile to monitor a number of passengers in an automobile, wherein the monitor includes:
an image capturing device, which successively captures a plurality of images in the automobile; and
a processing unit, which receives the images from the image capturing device to arrange an image sequence, wherein the processing unit includes an image dividing module, an image processing module, and a motion detecting module;
wherein the image dividing module divides each of the images into a plurality of recognition blocks;
wherein the image processing module compares the recognition blocks of consecutive images in the image sequence to acquire an image variance value;
wherein the motion detecting module has a threshold value and determines the recognition blocks as a human-present condition when the image variance value surpasses the threshold value.

2. The monitor of claim 1, wherein the image variance value is a distance of variance vector acquired from an intermediate coordinate that distinguishes two image trait blocks after the image processing module removes a background of the consecutive images in the image sequence.

3. The monitor of claim 1, wherein the consecutive images respectively includes a pixel matrix, and the image variance value is a sum of an absolute value of a subtraction between the pixel matrixes of the consecutive images.

4. The monitor of claim 1, wherein the consecutive images respectively includes a pixel matrix, and the image variance value is a proportion between the recognition blocks and a difference value matrix acquired from a subtraction between the pixel matrixes of the consecutive images.

5. The monitor of claim 1, wherein each of the recognition blocks respectively includes a depth reference range, and the image capturing device includes two cameras that measure the depths of the recognition blocks to detect whether there are objects within the depth reference range.

6. The monitor of claim 1, wherein each of the recognition blocks respectively includes a depth reference range, and the image capturing device is a depth camera that measures the depths of the recognition blocks to detect whether there are objects within the depth reference range.

7. The monitor of claim 1, wherein the processing unit includes a counter that records the number of people through the motion detecting module, and the monitor includes a wireless communication device that transmits data of the number of people to a remote server.

8. The monitor of claim 7, wherein the wireless communication device is established on the wireless communication system 3G, 4G, or Wi-Fi of a communication protocol.

9. The monitor of claim 1, which further includes a driver attention alarm, and the driver attention alarm includes another image capturing device that captures a facial image of the driver and records a number of winks in the facial image, and a warning indicator connected to the another image capturing device that sends out a warning when the number of winks in a stipulated time surpasses a first threshold value.

10. The monitor of claim 1, which further includes a driver attention alarm, and the driver attention alarm includes another image capturing device that captures a facial image of the driver and detects an angle of face turning in the facial image, and a warning indicator connected to the another image capturing device that sends out a warning when the angle of face turning surpasses a second threshold value.

11. A method for monitoring a number of passengers in an automobile, including:
a) successively capturing a plurality of images in the automobile through an image capturing device, and arranging the images into an image sequence;
b) dividing each image of the image sequence into a plurality of recognition blocks;
c) comparing the recognition blocks of consecutive images in the image sequence to acquire an image variance value; and
d) comparing the image variance value with a threshold value, and when the image variance value surpasses the threshold value, determining the recognition block as a human-present condition.

12. The method of claim 11, wherein the image variance value is a distance of variance vector acquired from an intermediate coordinate that distinguishes two image trait blocks after the image processing module removes a background of the consecutive images.

13. The method of claim 11, wherein the consecutive images respectively includes a pixel matrix, and the image variance value is a sum of the absolute value of a subtraction between the pixel matrixes of the consecutive images.

14. The method of claim 11, wherein the consecutive images respectively includes a pixel matrix, and the image variance value is a proportion between the recognition blocks and a difference value matrix acquired from a subtraction between the pixel matrixes of the consecutive images

15. The method of claim 11, wherein each of the recognition blocks respectively includes a depth reference range, and in step b), the image capturing device measures the depths of the recognition blocks to detect whether there are objects within the depth reference range.

16. The method of claim 11, which further includes a step e), the step in which by the results of detecting the recognition blocks the number of passengers inside the automobile is counted and a warning indication is transmitted to a remote server when the number of passengers fails to reach a required number of regulation

17. A computer-readable recording medium, installed on an electronic device, wherein the computer-readable recording medium is recorded with a method for monitoring the number of passengers in automobiles, and the method is according to the method of any one of claims 11.
